(19) United States
(12) Patent Application Publication
(10) Pub. No.: US 2015/0088752 A1
(43) Pub. Date: Mar. 26, 2015

(54) METHODS, APPARATUS, SYSTEMS AND COMPUTER READABLE MEDIUMS FOR ANONYMIZED IDENTIFICATION OF PAYMENT CARD ACCOUNTS BELONGING TO A SAME ENTITY

(71) Applicant: MASTERCARD INTERNATIONAL INCORPORATED, PURCHASE, NY (US)

(72) Inventor: Justin Xavier Howe, Oakdale, NY (US)

(73) Assignee: MASTERCARD INTERNATIONAL INCORPORATED, PURCHASE, NY (US)

(21) Appl. No.: 14/032,580

(22) Filed: Sep. 20, 2013

(51) Int. Cl. G06Q 40/00

(52) U.S. Cl. CPC G06Q 40/00
USPC 705/51

(57) ABSTRACT

In one embodiment, a method includes receiving, by a processing device, data representing a plurality of payment card transactions made in association with payment card accounts, the data including personally identifiable information; anonymizing, by a processing device, the data by hashing the personally identifiable information; determining, by a processing device, a plurality of the payment card accounts that belong to a same entity based on the hashed personally identifiable information without decoding the hashed personally identifiable information to recover the personally identifiable information; and identifying, by a processing device, the determined plurality of payment card accounts as belonging to the same entity.

### BACKGROUND

Payment cards and payment cards accounts are used in a variety of situations. In some situations, a person or cardholder visits a merchant location and presents a payment card associated with a payment card account in order to initiate a purchase of goods and/or services from the merchant. In some other situations, information associated with the payment card account is supplied to the merchant electronically, such as for example via the Internet and/or other electronic system(s), sometimes referred to herein as ecommerce.

In either of the above situations, a transaction processing system receives data representing the transaction that has been requested in association with the payment card account. In most, if not all cases, the data includes an a payment card account number that is associated with the payment card account as well as various types of personal information associated with the cardholder. This personal information, sometimes referred to herein as personally identifiable information, often includes a name (first and last) of the cardholder, a full address associated with the cardholder, a condensed address associated with the cardholder, and/or an address postal code associated with the cardholder.

The transaction processing system may determine which transaction requests should be approved and may store data representing the approved ones of the transactions in a database.

In some situations, a cardholder may have more than one payment card. For example, the cardholder may have one or more payment cards associated with different brands (such as, for example, MasterCard, Visa, American Express or the like). Further, the cardholder may have one or more payment cards issued by different financial institutions.

A credit reporting agency, such as EXPERIAN, EQUIFAX and/or TRANSUNION, has the ability to generate a report (sometimes referred to as credit report or credit history) that identifies each such payment card account belonging to the cardholder. As is known, the credit reporting agency generates such a report on the basis of personal information (e.g., a social security number) associated with the cardholder. The report may thereafter be used in making a decision relating to the cardholder, for example, whether to approve an application from the cardholder for a new payment account.

### BRIEF DESCRIPTION OF THE DRAWINGS

FIG. 1 is a block diagram of a system that may be used in anonymized identification of payment card accounts belonging to a same entity, in accordance with some embodiments.

FIG. 2 is a tabular representation of data representing a plurality of payment card transactions, in accordance with some embodiments.

FIG. 3 is a flow chart of a method that may be used in anonymized identification of payment card accounts belonging to a same entity, in accordance with some embodiments.

FIG. 4 is a tabular representation of data representing a plurality of payment card transactions, after anonymizing, in accordance with some embodiments.

FIG. 5 is a flow chart of a method that may be used in anonymizing data, in accordance with some embodiments.

FIGS. 6A-6B are a flow chart of a method that may be used in anonymized identification of payment card accounts belonging to a same entity, in accordance with some embodiments.

FIGS. 7-12 are tabular representations of data representing a plurality of payment card transactions, after anonymizing, in accordance with some embodiments.

FIG. 13 is a block diagram of an architecture, in accordance with some embodiments.

### DETAILED DESCRIPTION

Notwithstanding the benefit of credit reports, it has been determined that it would be desirable to have the ability to identify payment accounts that belong to a same cardholder, household and/or other entity, without the need for a credit report inquiry that is based on personally identifiable information (e.g., social security number) associated with the entity, thereby maintaining the privacy of the entity. In some embodiments, the ability to identify payment accounts that belong to a same cardholder, household and/or other entity may help prevent fraud.

The identification of payment accounts that belong to a same cardholder, household and/or other entity, without the need for a credit report based on personally identifiable information (e.g., social security number) associated with the entity, is sometimes referred to herein as anonymized identification of payment accounts belonging to a same entity. The term “payment card account” may be used herein to refer to payment accounts that may be accessed by a card or other access device, however, those skilled in the art, upon reading this disclosure, will appreciate that different types of financial accounts may also be identified or analyzed using features of the present invention. For example, the term “payment card account” may refer to a financial account accessible by a mobile device, by near field communications (“NFC”) or other means. Further, the term “cardholder” is used to generally refer to an account holder or other individual or entity associated with a payment or other financial account. Neither the term “payment card account” or “cardholder” are meant to limit the disclosure to accounts accessible only by a physical card.

In some embodiments, the above may be accomplished using data that is stored in a transaction processing system and anonymized.

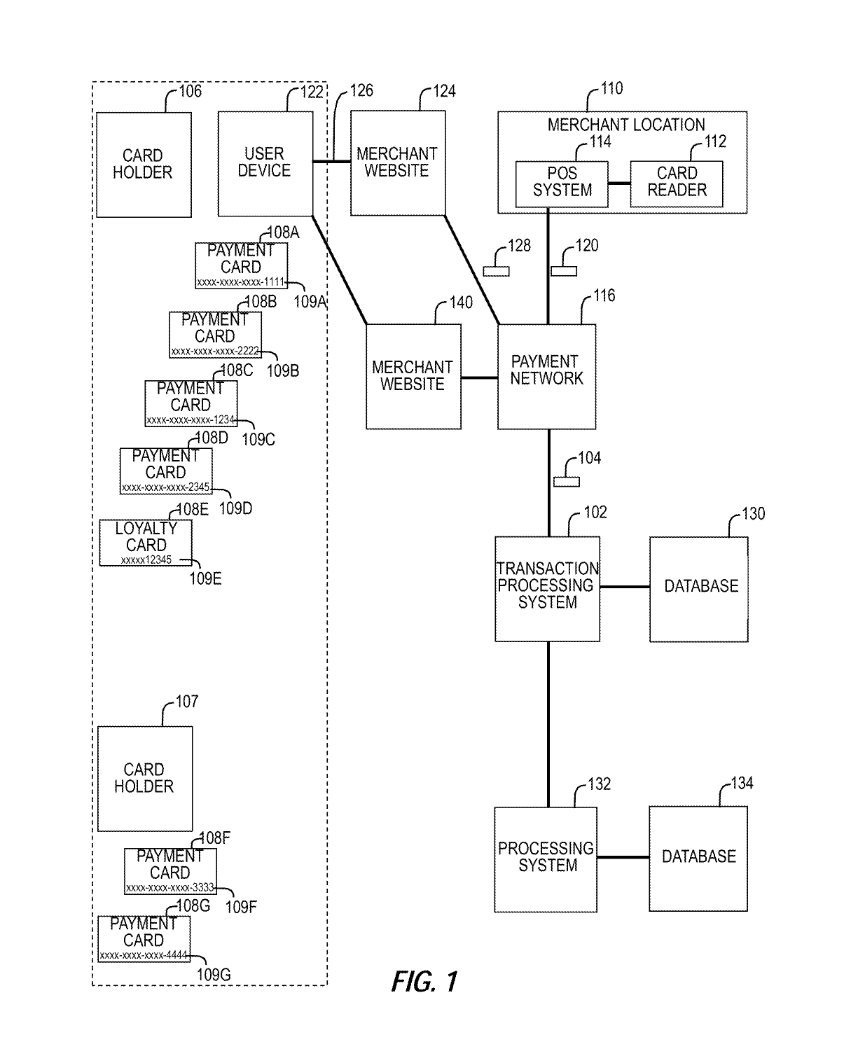

FIG. 1 is a block diagram of a system 100 that may be used in anonymized identification of payment card accounts belonging to a same entity, in accordance with some embodiments.

Referring to FIG. 1, the system 100 includes a transaction processing system 102 that receives data 104 representing transactions requested in association with payment card accounts.

For example, in accordance with some embodiments, a first cardholder 106 has been issued a plurality of payment cards 108A-108D each of which is associated with a respective one of a plurality of payment card accounts and includes a payment card account number 109A-109D, respectively. The first cardholder 106 has also been issued a loyalty (e.g., rewards) card 108E that is associated with a merchant loyalty (e.g., rewards) program and includes a loyalty card number 109E. Each of the plurality of payment cards 108A-108D, may further include (e.g., stored thereon) personal information associated with the cardholder, such as, for example, the name of the first cardholder 106 and a full address associated with the first cardholder 106.

A second cardholder 107, who may reside in a same household as the first cardholder, has also been issued a plurality of payment cards 108F-108G each of which is associated with a respective one of a plurality of payment card accounts and includes a payment card account number 109F-109G, respectively. Each of the plurality of payment cards 108F-108G, may further include (e.g., stored thereon) personal information associated with the second cardholder 107, such as, for example, the name of the second cardholder 107 and a full address associated with the second cardholder 107.

The first cardholder 106 may visit a merchant location 110 with a goal of purchasing goods (and/or services) from the merchant. The merchant location 110 may include a payment card reader 112, which may be connected to a point of sale (POS) system 114. The POS system 114 may be connected to a payment network 116, which in turn may be connected to the transaction processing system 102. The first cardholder 106 may present one of the payment cards, e.g., payment card 108A, to the payment card reader 112 to initiate the purchase. In response, the payment card reader 112 may receive information from the payment card 108A and may supply the information to the POS system 114. The POS system 114 may respond by supplying data representing a transaction request 120 to the payment network 116, which in turn may supply the data to the transaction processing system 102.

The first cardholder 106 may also or alternatively supply information to the merchant electronically, sometimes referred to herein as ecommerce. For example, in accordance with some embodiments, the first cardholder 106 may have a computer and/or other type of user device 122 that is connected to a merchant website 124 via a network 126, e.g., the Internet. The first cardholder 106 may supply payment card account information to the user device 122, which may supply the information to the merchant website 124. The merchant website 124 may respond by supplying data representing a transaction request 128 to the payment network 116, which in turn may supply the data to the transaction processing system 102.

In either of the above situations, the transaction processing system 102 receives data representing a transaction that has been requested in association with the payment card account. In most, if not all cases, the data includes an a payment card account number that is associated with the payment card account as well as various types of personal information associated with the cardholder, sometimes referred to herein as personally identifiable information.

In accordance with some embodiments, the personally identifiable information received by the transaction processing system 102 may include a full name of the cardholder, a full address (e.g., a street name, a street number, a city, a state and a postal code) associated with the cardholder, a condensed version of the full address (sometimes referred to herein as a condensed address, e.g., a street name, a street number and a postal code), a postal code portion of the full address, and/or a loyalty card number assigned to the cardholder and used in the transaction.

In some embodiments, the data 104 received by the transaction processing system 102 in association with any given transaction request depends at least in part on whether the payment card was presented in person at a merchant location or whether information from the payment card was supplied to the merchant electronically.

For example, if the payment card was presented in person, the transaction processing system may receive one, some or all portions of the information stored on the payment card. This may include, for example, the payment card account number associated with the payment card, a name (first and last) of a cardholder to which the payment card is issued and a full address associated with the cardholder. If information associated with the payment card was supplied to the merchant electronically, the transaction processing system may receive the payment account number and either a full address associated with the cardholder, a condensed address associated with the cardholder or just a postal code associated with the cardholder.

In some situations, additional information is received by the transaction processing system 102. For example, if a merchant, e.g., a merchant operating merchant location 110, offers a loyalty (e.g., rewards) program and the first cardholder 106 participates in such program, the transaction processing system 102 may receive a loyalty card number assigned to the cardholder.

As another example, if the first cardholder 106 uses a payment card account to transact with a merchant (e.g., via a merchant website 140) in order to purchase a ticket for air or rail travel and/or to reserve a hotel room and/or a rental car, the transaction processing system 102 may receive a clearing addenda that includes the name of the cardholder (or a traveler that will use the ticket) and a loyalty card number assigned to the cardholder, if appropriate. At present, government regulations require that the cardholder purchasing a ticket for air travel supply a name of a traveler (passenger) that will use the ticket.

As with the first cardholder, 106, the second cardholder 107 may initiate payment card transactions, albeit using the payment cards 108F-108G issued to the second cardholder 107 rather than payment cards 108A-108D issued to the first cardholder 106.

The transaction processing system 102 may determine which of the transaction requests should be approved and may store data representing the approved ones of the transactions (sometimes referred to herein as payment card transactions) in a database 130, which may be connected to and/or included in the transaction processing system 102.

The transaction processing system 102 may be connected to one or more other processing systems 132, which may be connected to and/or include a database 134. One or more of such other processing systems may comprise an issuer processing system and/or a financial institution processing system.

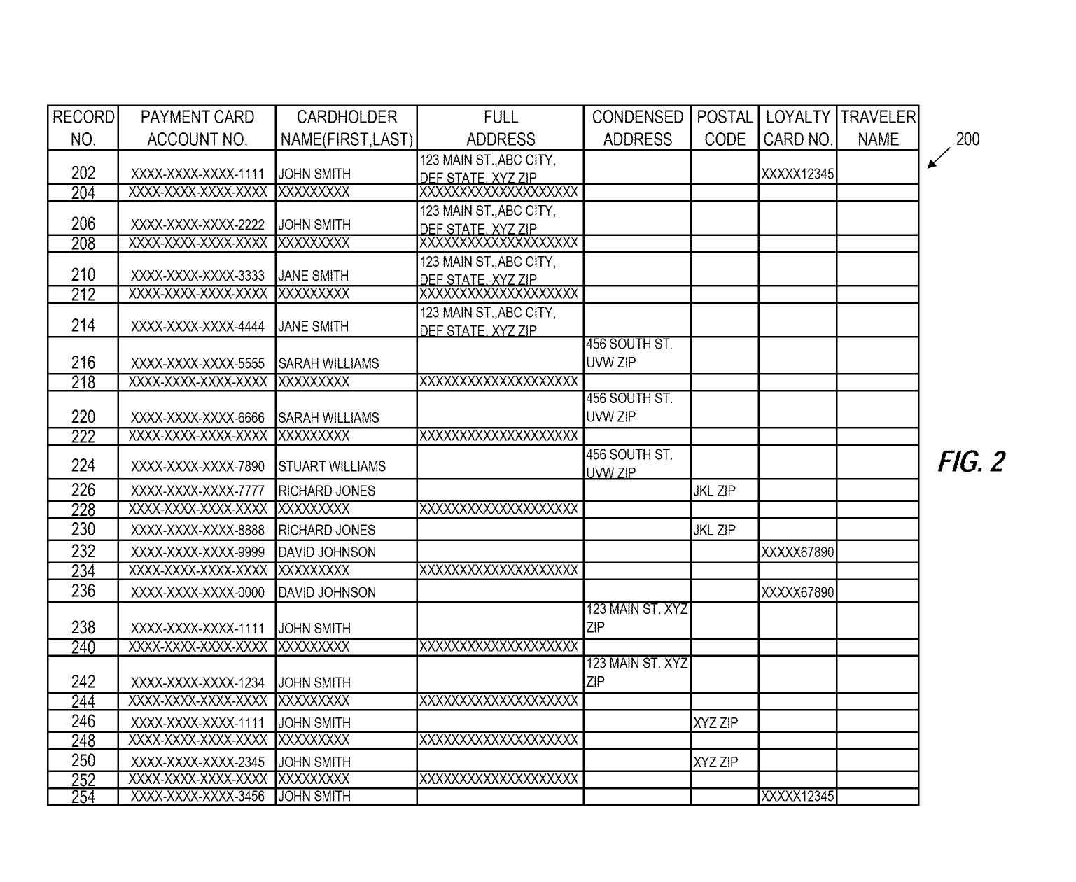

FIG. 2 is a tabular representation 200 of data that may be stored in the database 130 as representing a plurality of payment card transactions, in accordance with some embodiments.

Referring to FIG. 2, the data is shown in the form of a plurality of records, e.g., records 202-254, each of which is shown in a respective row of the table 200 and represents a respective one of a plurality of payment card transactions.

For example, a first record 202 shown in a first row of the table 200 represents a first payment card transaction. A second record 204 shown in a second row of the table 200 represents a second payment card transaction. And so on.

Each record includes a payment card account number involved in the respective payment card transaction. Each record further includes personally identifiable information associated with the cardholder.

For example, the first record 202 includes the payment card account number “XXXX-XXXX-XXXX-1111”, a cardholder name “JOHN SMITH”, a full address “123 MAIN STREET, ABC CITY, DEF STATE, XYZ ZIP” and a loyalty card number “XXXXX12345”. A third record 206 includes a payment card account number “XXXX-XXXX-XXXX-2222”, a cardholder name “JOHN SMITH” and a full address “123 MAIN STREET, ABC CITY, DEF STATE, XYZ ZIP”.

Although each of the payment card account numbers in table 200 are represented schematically as having 16 digits with 12 leading X's, this does not mean that the payment card account numbers in such records must actually have 16 digits and/or 12 leading X's. Nor does it mean that the all of the payment card account numbers have the same 12 leading digits.

In some embodiments, one or more of the first 6 digits of a payment card account number represent an issuer identification number (IIN), previously referred to as a bank identification number (BIN). For example, in some embodiments, payment card account numbers issued by a first issuer begin with a first sequence of 6 digits”, and payment card account numbers issued by another issuer will begin with some sequence of 6 digits other than the first sequence of digits.

In some embodiments, all of the payment card account numbers in table 200 are issued by a same issuer. For example, in some embodiments, all of the payment card account numbers in table 200 are issued by a first issuer of payment cards (and, in some embodiments, are associated with a first brand of payment cards).

In some other embodiments, one or more of the payment card account numbers in table 200 are issued by different issuers. For example, in some embodiments, one or more of the payment card account numbers in table 200 are issued by a first issuer of payment cards and one or more others of the payment card account numbers in table 200 are issued by one or more other issuers (and, in some embodiments, may be associated with the first or other brand of payment cards).

Records that need not be discussed in detail have been represented schematically by a payment card account number consisting of all X's, a cardholder name consisting of all X's and a full address consisting of all X's. See records 204, 208, 212, 218, 222, 228, 234, 240, 244, 248 and 252. However, this does not mean that the payment card account number, the cardholder name and the full address for these records are all X's.

Hereinafter, to minimize distraction, these records are represented schematically as all blanks. However, this does not mean that the payment card account number, the cardholder name and the full address for these records are actually blank.

Although the plurality of records are shown in a table 200, with each record shown in a respective row and each type of information (sometimes referred to herein as a field) included in the record shown in a column defined for such type of information, it should be understood that the plurality of records may be organized and/or stored in any manner.

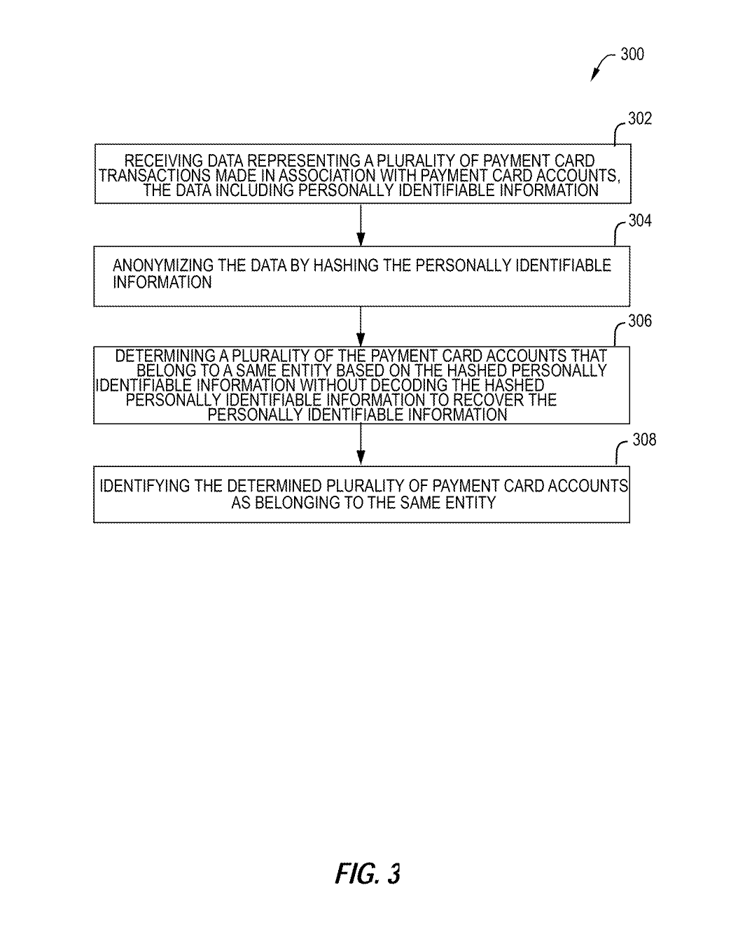

FIG. 3 is a flow chart of a method 300 that may be used in anonymized identification of payment card accounts belonging to a same entity, in accordance with some embodiments. It should be noted that the method 300 and/or any other method described herein may be performed by hardware, software (which may include low level language code and/or high language code), or any combination thereof. In some embodiments, one or more portions of the method may be performed by one or more portions of the system 100.

Referring to FIG. 3, at 302, the method may include receiving data representing a plurality of payment card transactions made in association with a payment card accounts.

At 304, the method may further include anonymizing the data by hashing personally identifiable information included in the data.

At 306, the method may further include determining, by a processing device, a plurality of the payment card accounts that belong to a same entity based on the hashed personally identifiable information without decoding the hashed personally identifiable information to recover the personally identifiable information.

In some embodiments, the entity is a cardholder or household.

At 308, the method may further include identifying the determined plurality of the payment card accounts as belonging to the same entity.

In some embodiments, the anonymizing at 304 is performed by a different department and/or organization than the determining at 306 and the identifying at 308.

In some embodiments, the anonymizing is performed by the transaction processing system and the determining/identifying are performed by one or more of the one or more other processing systems 132.

Separating the performance of the anonymizing from the performance of the determining/identifying helps to further safeguard the personally identifiable information associated with the cardholder.

In some embodiments, all of the payment card account numbers identified as belonging to a same entity are issued by a same issuer. For example, in some embodiments, all of the payment card account numbers identified as belonging to a same cardholder are issued by a first issuer of payment cards.

In some other embodiments, one or more of the payment card account numbers identified as belonging to a same entity are issued by different issuers. For example, in some embodiments, one or more of the payment card account numbers identified as belonging to a same cardholder are issued by a first issuer of payment cards and one or more others of the payment card account numbers identified as belonging to the cardholder are issued by one or more other issuers.

It should be noted that the method 300 is not limited to the order shown in the flow chart. Rather, embodiments of the method 300 may be performed in any order that is practicable. For that matter, unless stated otherwise, any method disclosed herein may be performed in any order that is practicable. Notably, some embodiments may employ one or more portions of a method without one or more other portions of the method.

It should also be noted that in some embodiments, a non-transitory computer readable medium may have instructions stored thereon, which if executed by a machine result in performance of the method 300 (or one or more portions thereof) and/or any other method (or portion thereof) described herein.

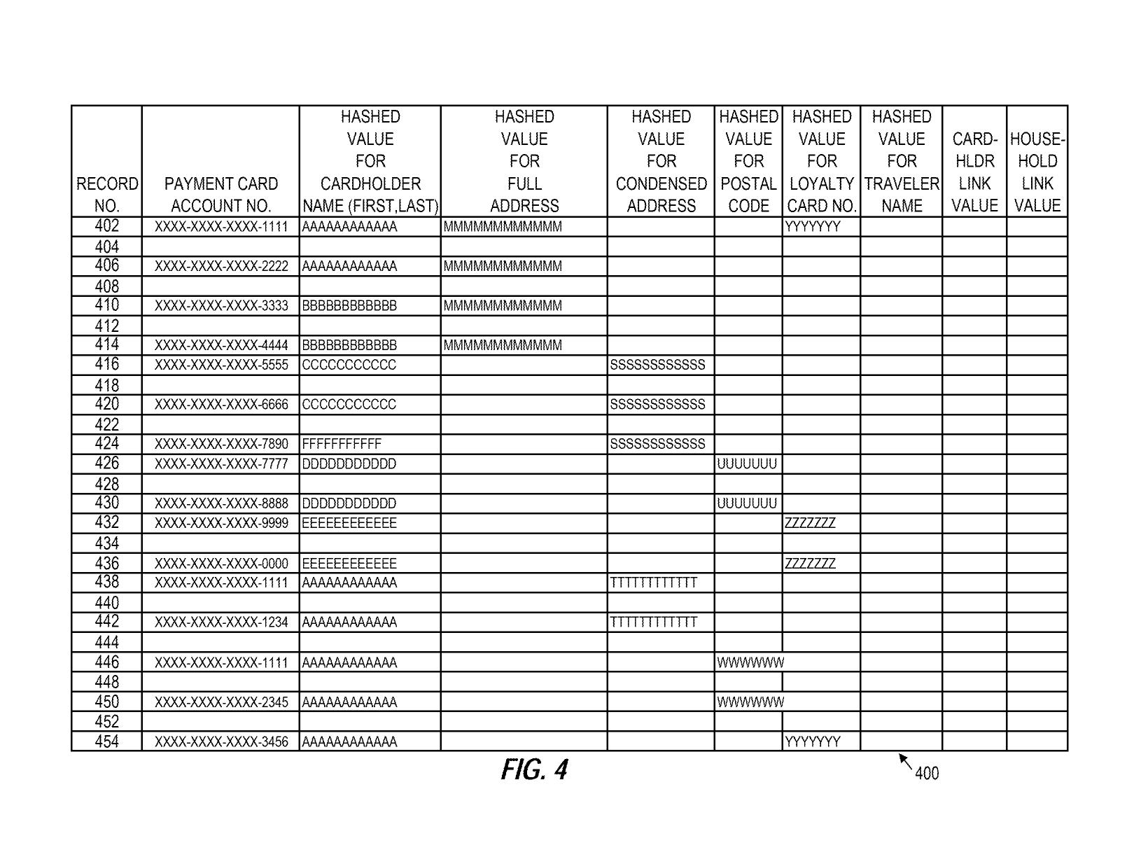

FIG. 4 is a tabular representation 400 of the data of table 200 after anonymizing at 304, in accordance with some embodiments. Referring to FIG. 4, the data is shown in the form of a plurality of records, e.g., records 402-454, each of which is shown in a respective row of the table 400 and represents a same payment card transaction as was represented by a corresponding one of the plurality of records, e.g., records 202-254, in table 2.

Thus, a first record 402 in the table 400 represents the same payment card transaction as represented by the first record 202 in the table 200. A second record 404 in the table 400 represents the same payment card transaction as represented by the second record 204 in the table 200. A third record 406 in the table 400 represents the same payment card transaction as represented by the third record 206 in the table 200. And so on.

In the table 400, the data has been anonymized by replacing each instance of personally identifiable information with a hashed value generated for such instance of personally identifiable information. Each hash value is represented schematically as a string of letters, e.g., “AAAAAAAAAAAA”.

It should be noted that each string bears no resemblance to the actual hash value represented by such string. However, identical strings indicate that the hashed values represented by such strings are identical, which in turn indicates that the instances of personally identifiable information (for which the hash values were generated) are identical.

For example, the first record 402 in the table 400 includes the payment card account number “XXXX-XXXX-XXXX-1111”, a hashed value (represented by a string “AAAAAAAAAAAA”) for the cardholder name “JOHN SMITH”, a hashed value (represented by a string “MMMMMMMMMMMM”) for the full address “123 MAIN STREET, ABC CITY, DEF STATE, XYZ ZIP” and a hashed value (represented by a string “YYYYYYY”) for the loyalty card number “XXXXX12345”.

A third record 406 includes the payment card account number “XXXX-XXXX-XXXX-2222”, a hashed value (represented by a string “AAAAAAAAAAAA”) for the cardholder name “JOHN SMITH” and a hashed value (represented by a string “MMMMMMMMMMMM”) for the full address “123 MAIN STREET, ABC CITY, DEF STATE, XYZ ZIP”. And so on.

The string “AAAAAAAAAAAA” representing the hashed value for the cardholder name in the first record 402 and the string “AAAAAAAAAAAA” representing the hashed value for the cardholder name in the third record 406 are identical, which indicates that the hashed values are identical, which in turn indicates that the cardholder name in the first record 402 is identical to the cardholder name in the third record 406.

The string “MMMMMMMMMMMM” representing the hashed value for the full address in the first record 402 and the string “MMMMMMMMMMMM” representing the hashed value for the full address in the third record 406 are identical, which indicates that the hashed values are identical, which in turn indicates that the full address in the first record 402 is identical to the full address in the third record 406.

As stated above, records that need not be discussed in detail have been represented schematically as all blanks. See records 404, 408, 412, 418, 422, 428, 434, 440, 444, 448 and 452. However, this does not mean that the payment card account number, the cardholder name and the full address for these records are actually blank.

In accordance with some embodiments, one purpose for generating hash values for the personally identifiable information associated with the cardholder is to help safeguard the personally identifiable information associated with the cardholder. Thus, in accordance with some embodiments, a hash value will be deterministic (i.e., generated based on the information being hashed) and one way (i.e., generated using a function that does not permit recovery of the original personally identifiable information).

In accordance with some embodiments, the methods disclosed herein may not used to identify payment card accounts belonging to a particular cardholder unless that particular cardholder has consented to the use of such methods to identify such.

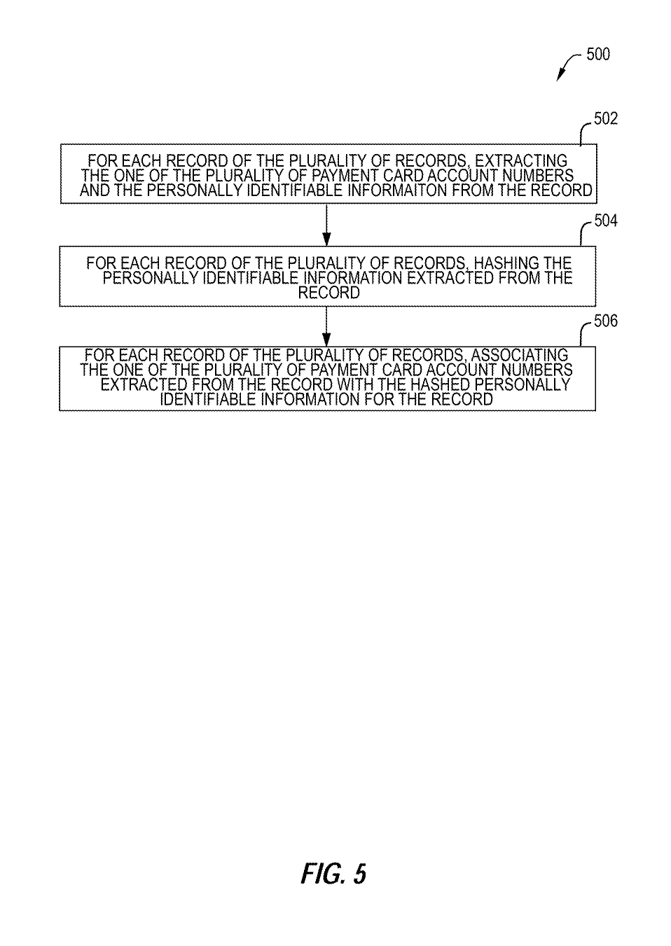

FIG. 5 is a flow chart of a method 500 that may be used in generating anonymized data (e.g., in table 400) from non-anonymized data (e.g., in table 200), in accordance with some embodiments.

At 502, the method may include, for each record of the plurality of records (e.g., in table 200), extracting the one of the plurality of payment card account numbers and the personally identifiable information from the record.

In some embodiments, personally identifiable information within a record is divided into separate fields, e.g., a full address, a condensed address, a name of a traveler (passenger), a loyalty card number and/or a postal code.

At 504, the method may further include, for each record of the plurality of records (e.g., in table 200), hashing the personally identifiable information extracted from the record.

If the personally identifiable information within a record is divided into separate fields, the hashing of such personally identifiable information may comprise generating a plurality of hash values, each associated with a respective one of the fields.

In some embodiments, the hashed personally information includes a hashed value for the name of the cardholder and further includes a hashed value for a full address, a hashed value for a condensed address, a hashed value for a name of a traveler (passenger), a hashed value for a loyalty card number and/or a hashed value for a postal code.

At 506, the method may further include, for each record of the plurality of records (e.g., in table 200), associating the one of the plurality of payment card account numbers extracted from the record with the hashed personally identifiable information for the record.

In some embodiments, the associating of the one of the plurality of payment card account numbers extracted from the record with the hashed personally identifiable information for the record comprises: creating a record (e.g., in table 400) that includes the one of the plurality of payment card account numbers extracted from the record and the hashed personally identifiable information for the record.

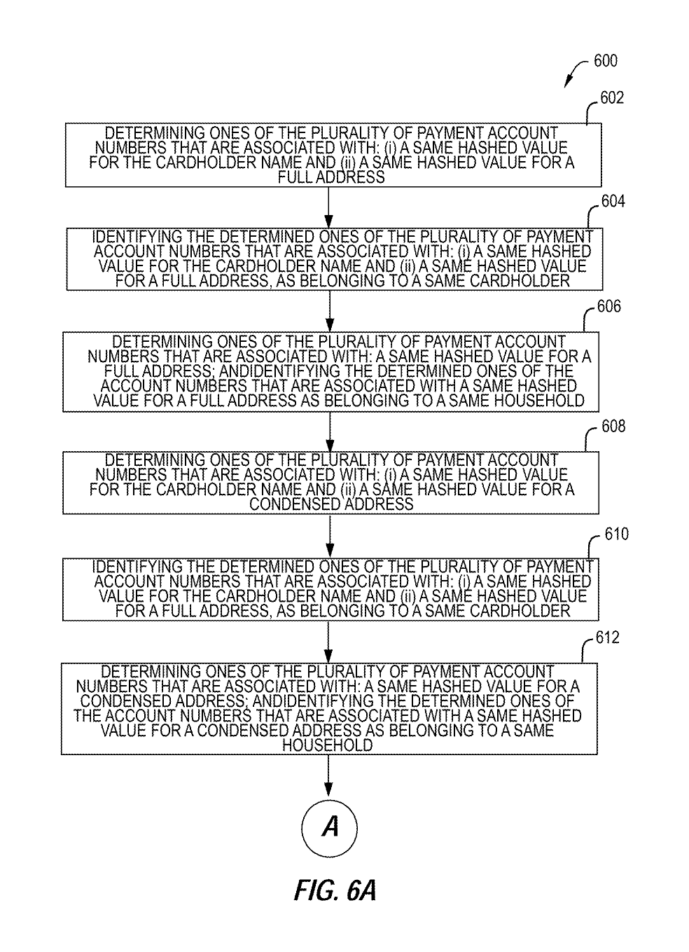

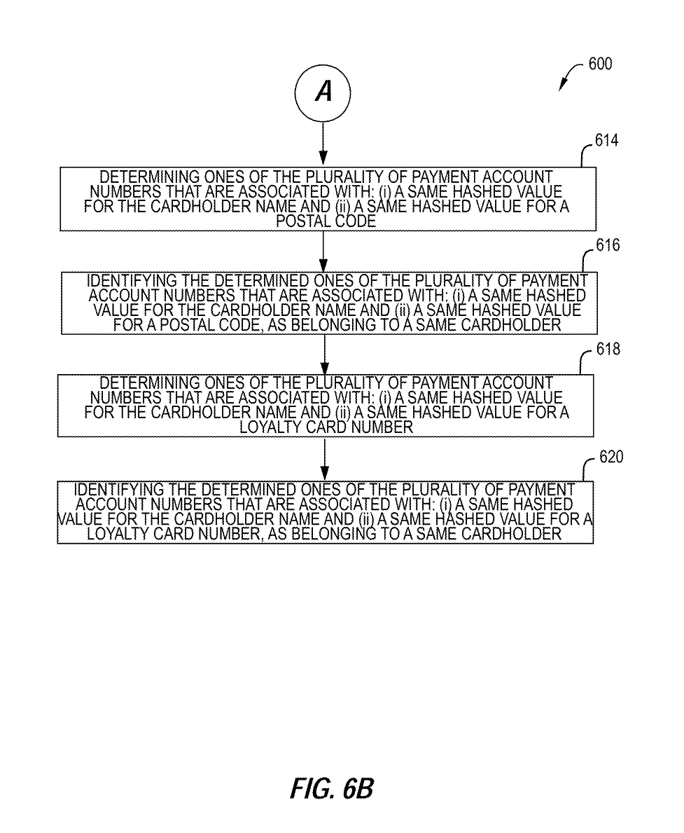

FIGS. 6A-6B are a flow chart of a method 600 that may be used in performing 306-308 of method 300, in accordance with some embodiments.

Referring to FIG. 6A, at 602, the method may include determining ones of the plurality of payment account numbers that are associated with: (i) a same hashed value for the cardholder name and (ii) a same hashed value for a full address.

At 604, the method may further include identifying the determined ones of the plurality of payment account numbers that are associated with: (i) a same hashed value for the cardholder name and (ii) a same hashed value for a full address, as belonging to a same cardholder.

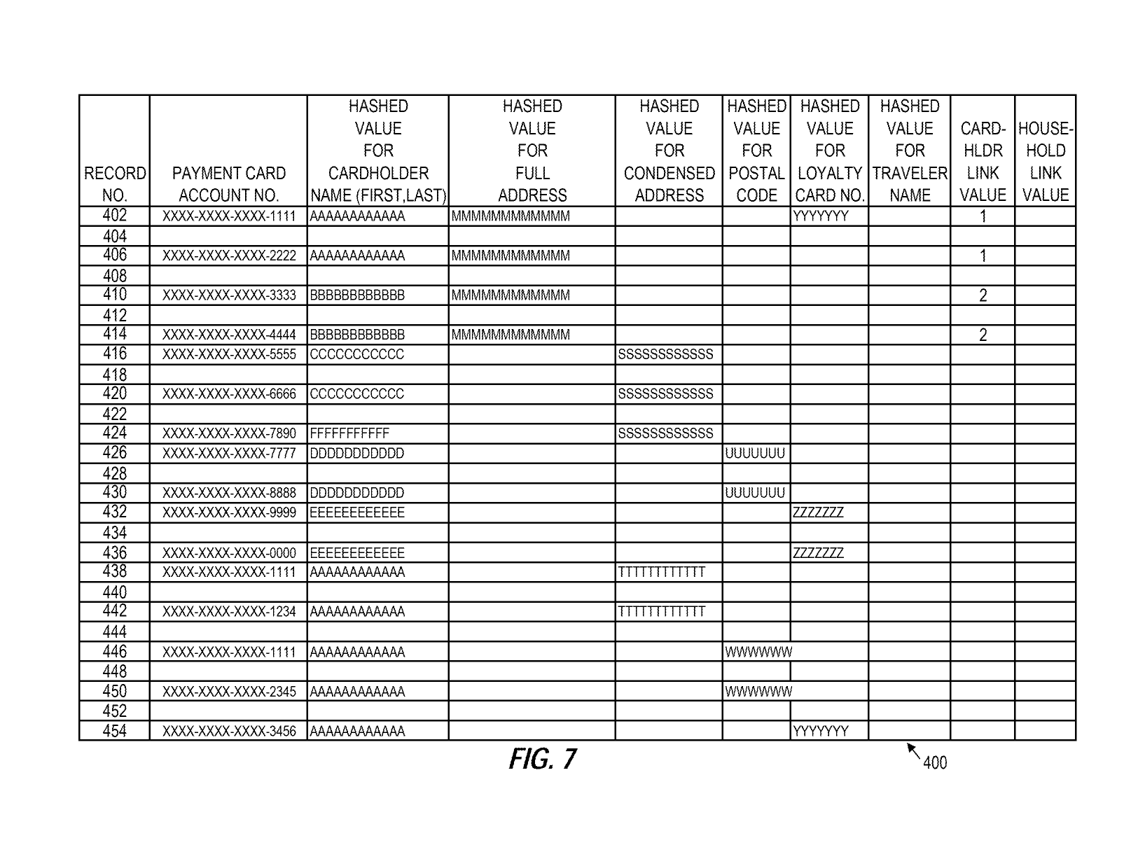

FIG. 7 shows the data of table 400 after 602-604, in accordance with some embodiments.

Referring to FIG. 7, the payment card account number XXXX-XXXX-XXXX-1111 in the first record 402 and the payment card account number XXXX-XXXX-XXXX-2222 in the third record 406 have been determined as being associated with: (i) a same hashed value for the cardholder name (e.g., a hashed value represented by the string “AAAAAAAAAAAA”) and (ii) a same hashed value for a full address (e.g., a hashed value represented by the string “MMMMMMMMMMMM”).

In accordance with some embodiments, a cardholder link value (e.g., “1”) in the record 402 and the record 406 identify the payment card account number XXXX-XXXX-XXXX-1111 in the first record 402 and the payment card account number XXXX-XXXX-XXXX-2222 in the third record 406 as belonging to the same cardholder.

Similarly, the payment card account number XXXX-XXXX-XXXX-3333 in the record 410 and the payment card account number XXXX-XXXX-XXXX-4444 in the record 414 have been determined as being associated with: (i) a same hashed value for the cardholder name (e.g., a hashed value represented by the string “BBBBBBBBBBBB”) and (ii) a same hashed value for a full address (e.g., a hashed value represented by the string “MMMMMMMMMMMM”).

In accordance with some embodiments, a cardholder link value (e.g., “2”) in the record 410 and the record 414 identify the payment card account number XXXX-XXXX-XXXX-3333 in the record 410 and the payment card account number XXXX-XXXX-XXXX-4444 in the record 414 as belonging to the same cardholder.

Referring again to FIG. 6A, at 606, the method may further include determining ones of the plurality of payment account numbers that are associated with a same hashed value for a full address; and identifying the determined ones of the plurality of payment account numbers that are associated with a same hashed value for a full address, as belonging to a same household.

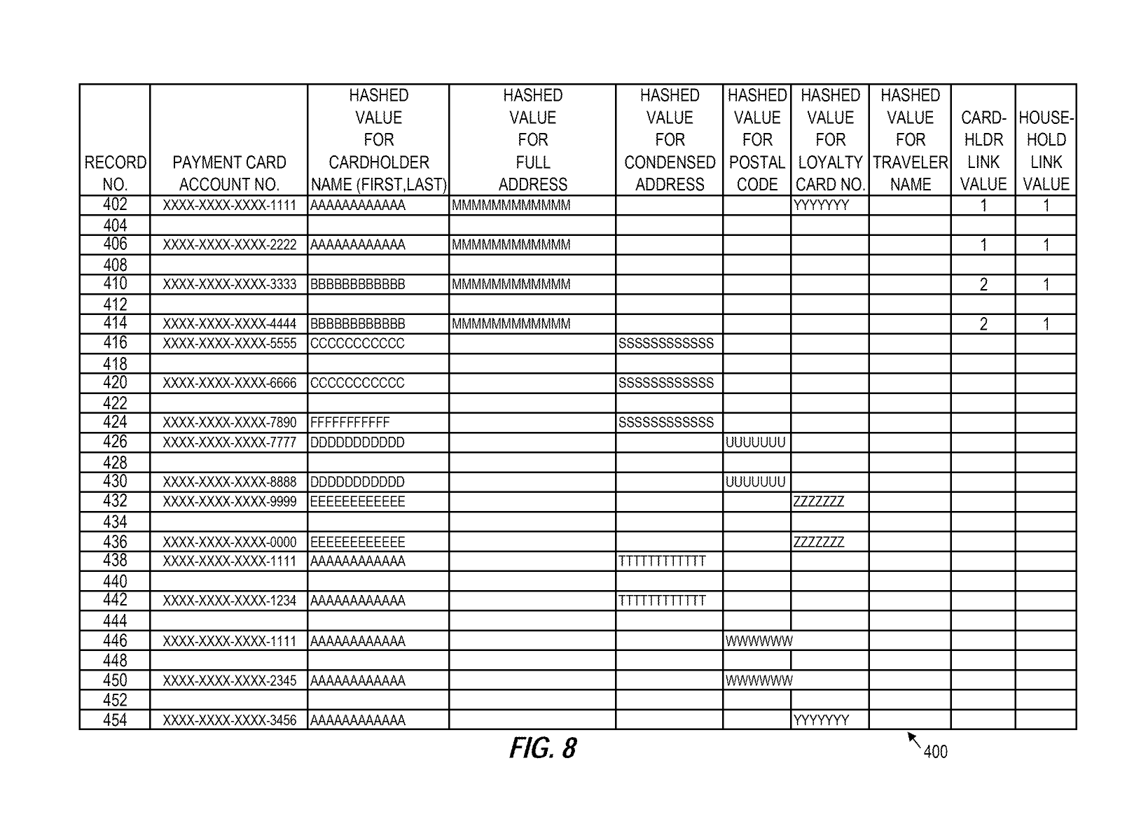

FIG. 8 shows the data of table 400 after 606, in accordance with some embodiments.

Referring to FIG. 8, the payment card account number XXXX-XXXX-XXXX-1111 in the record 402, the payment card account number XXXX-XXXX-XXXX-2222 in the record 406, the payment card account number XXXX-XXXX-XXXX-3333 in the record 410 and the payment card account number XXXX-XXXX-XXXX-4444 in the record 414 have been determined as being associated with a same hashed value for a full address (e.g., a hashed value represented by the string “MMMMMMMMMMMM”).

In accordance with some embodiments, a household link value (e.g., “1”) in the records 402, 406, 410 and 414 identify the payment card account number XXXX-XXXX-XXXX-1111 in the record 402, the payment card account number XXXX-XXXX-XXXX-2222 in the record 406, the payment card account number XXXX-XXXX-XXXX-3333 in the record 410 and the payment card account number XXXX-XXXX-XXXX-4444 in the record 414 as belonging to the same household.

Referring again to FIG. 6A, at 608, the method may further include determining ones of the plurality of payment account numbers that are associated with: (i) a same hashed value for the cardholder name and (ii) a same hashed value for a condensed address.

At 610, the method may further include identifying the determined ones of the plurality of payment account numbers that are associated with: (i) a same hashed value for the cardholder name and (ii) a same hashed value for a condensed address, as belonging to a same cardholder.

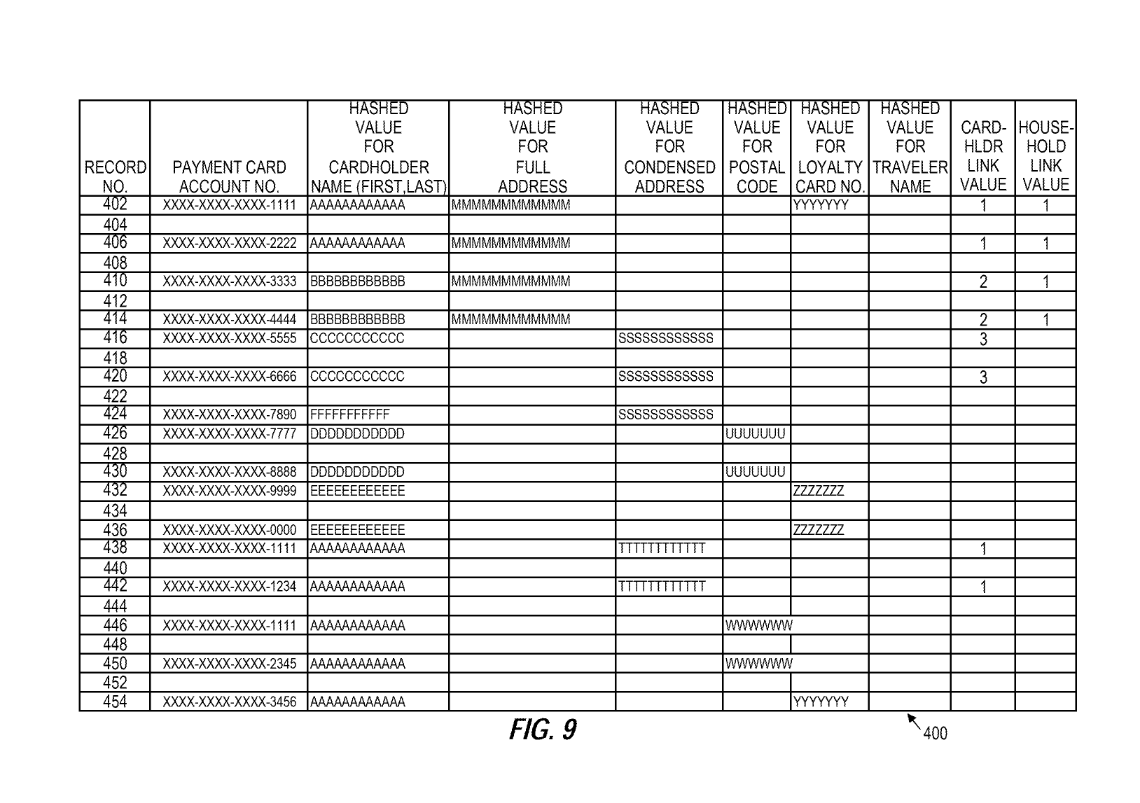

FIG. 9 shows the data of table 400 after the 608-610, in accordance with some embodiments.

Referring to FIG. 9, the payment card account number XXXX-XXXX-XXXX-5555 in the record 416 and the payment card account number XXXX-XXXX-XXXX-6666 in the record 420 have been determined as being associated with: (i) a same hashed value for the cardholder name (e.g., a hashed value represented by the string “CCCCCCCCCCC”) and (ii) a same hashed value for a condensed address (e.g., a hashed value represented by the string “SSSSSSSSSSSS”).

In accordance with some embodiments, a cardholder link value (e.g., “3”) in the records 416 and 420 identify the payment card account number XXXX-XXXX-XXXX-5555 in the record 416 and the payment card account number XXXX-XXXX-XXXX-6666 in the record 420 as belonging to the same cardholder.

Similarly, the payment card account number XXXX-XXXX-XXXX-1111 in the record 438 and the payment card account number XXXX-XXXX-XXXX-1234 in the record 442 have been determined as being associated with: (i) a same hashed value for the cardholder name (e.g., a hashed value represented by the string “AAAAAAAAAAAA) and (ii) a same hashed value for a condensed address (e.g., a hashed value represented by the string “TTTTTTTTTTTT”).

In accordance with some embodiments, a cardholder link value (e.g., “1”) in the records 438 and 442 identify the payment card account number XXXX-XXXX-XXXX-1111 in the record 438 and the payment card account number XXXX-XXXX-XXXX-1234 in the record 442 as belonging to the same cardholder.

Thus, in accordance some embodiments, the payment card account number XXXX-XXXX-XXXX-1111 in the records 402, 438, the payment card account number XXXX-XXXX-XXXX-2222 in the record 406 and the payment card account number XXXX-XXXX-XXXX-1234 in the record 442, have been determined as belonging to a same cardholder and identified as belonging to the same cardholder.

Referring again to FIG. 6A, at 612, the method may further include determining ones of the plurality of payment account numbers that are associated with a same hashed value for a condensed address; and identifying the ones of the plurality of payment account numbers that are associated with a same hashed value for a condensed address, as belonging to a same household.

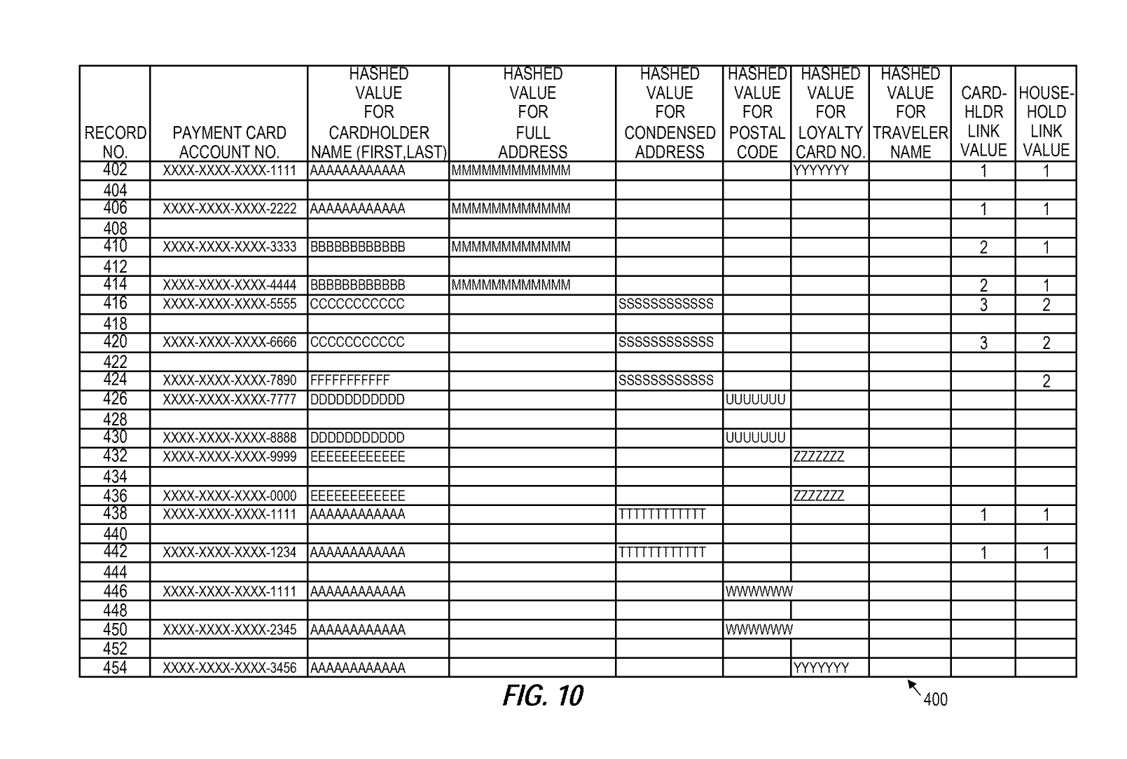

FIG. 10 shows the data of table 400 after 612, in accordance with some embodiments.

Referring to FIG. 10, the payment card account number XXXX-XXXX-XXXX-5555 in the record 416, the payment card account number XXXX-XXXX-XXXX-666 in the record 420, the payment card account number XXXX-XXXX-XXXX-7890 in the record 424 have been determined as being associated with a same hashed value for a condensed address (e.g., a hashed value represented by the string “SSSSSSSSSSSS”).

In accordance with some embodiments, a household link value (e.g., “2”) in the records 416, 420, 424 identify the payment card account number XXXX-XXXX-XXXX-5555 in the record 416, the payment card account number XXXX-XXXX-XXXX-6666 in the record 420, the payment card account number XXXX-XXXX-XXXX-7890 in the record 424 as belonging to the same household.

Similarly, the payment card account number XXXX-XXXX-XXXX-1111 in the record 438 and the payment card account number XXXX-XXXX-XXXX-1234 in the record 442 have been determined as being associated with a same hashed value for a condensed address (e.g., a hashed value represented by the string “TTTTTTTTTTTT”).

In accordance with some embodiments, a household link value (e.g., “1”) in the records 438 and 442 identify the payment card account number XXXX-XXXX-XXXX-1111 in the record 438 and the payment card account number XXXX-XXXX-XXXX-1234 in the record 4442 as belonging to the same household.

Thus, in accordance with some embodiments, the payment card account number XXXX-XXXX-XXXX-1111 in the records 402, 438, the payment card account number XXXX-XXXX-XXXX-2222 in the record 406, the payment card account number XXXX-XXXX-XXXX-3333 in the record 410, the payment card account number XXXX-XXXX-XXXX-4444 in the record 414 and the payment card account number XXXX-XXXX-XXXX-1234 in the record 442 have been determined as belonging to a same household and identified as belonging to the same household.

Referring to FIG. 6B, at 614, the method may further include determining ones of the plurality of payment account numbers that are associated with: (i) a same hashed value for the cardholder name and (ii) a same hashed value for a postal code.

At 616, the method may further include identifying the determined ones of the plurality of payment account numbers that are associated with: (i) a same hashed value for the cardholder name and (ii) a same hashed value for a postal code, as belonging to a same cardholder.

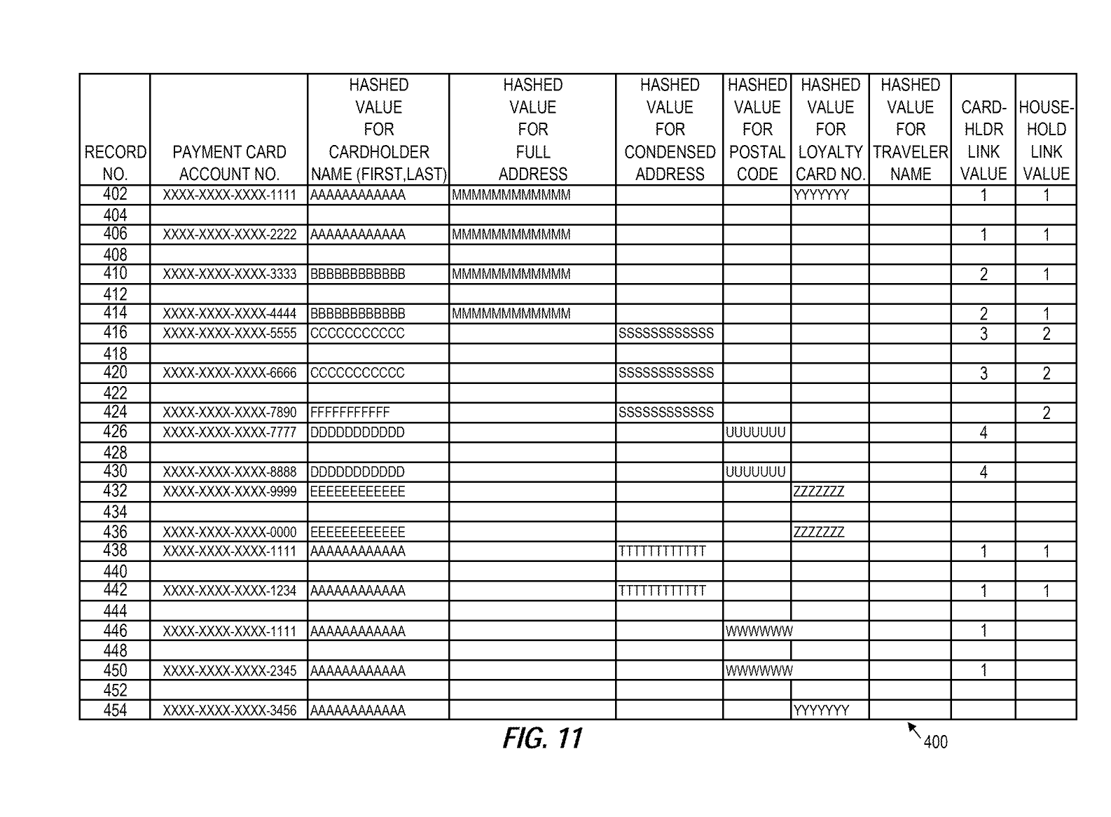

FIG. 11 shows the data of table 400 after 614-616, in accordance with some embodiments.

Referring to FIG. 11, the payment card account number XXXX-XXXX-XXXX-7777 in the record 426 and the payment card account number XXXX-XXXX-XXXX-8888 in the record 430 have been determined as being associated with: (i) a same hashed value for the cardholder name (e.g., a hashed value represented by the string “DDDDDDDDDDD”) and (ii) a same hashed value for a postal code (e.g., a hashed value represented by the string “UUUUUUU”).

In accordance with some embodiments, a cardholder link value (e.g., “4”) in the records 426 and 430 identify the payment card account number XXXX-XXXX-XXXX-7777 in the record 426 and the payment card account number XXXX-XXXX-XXXX-8888 in the record 430 as belonging to the same cardholder.

Similarly, the payment card account number XXXX-XXXX-XXXX-1111 in the record 446 and the payment card account number XXXX-XXXX-XXXX-2345 in the record 450 have been determined as being associated with: (i) a same hashed value for the cardholder name (e.g., a hashed value represented by the string “AAAAAAAAAAAA) and (ii) a same hashed value for a postal code (e.g., a hashed value represented by the string “WWWWWW”).

In accordance with some embodiments, a cardholder link value (e.g., “1”) in the records 446 and 450 identify the payment card account number XXXX-XXXX-XXXX-1111 in the record 446 and the payment card account number XXXX-XXXX-XXXX-2345 in the record 450 as belonging to the same cardholder.

Thus, in accordance some embodiments, the payment card account number XXXX-XXXX-XXXX-1111 in the records 402, 438, 446, the payment card account number XXXX-XXXX-XXXX-2222 in the record 406, the payment card account number XXXX-XXXX-XXXX-1234 in the record 442 and the payment card account number XXXX-XXXX-XXXX-2345 in the record 450, have been determined as belonging to a same cardholder and identified as belonging to the same cardholder.

Referring again to FIG. 6B, at 618, the method may further include determining ones of the plurality of payment account numbers that are associated with: (i) a same hashed value for the cardholder name and (ii) a same hashed value for a loyalty card number.

At 620, the method may further include identifying the determined ones of the plurality of payment account numbers that are associated with: (i) a same hashed value for the cardholder name and (ii) a same hashed value for a loyalty card number, as belonging to a same cardholder.

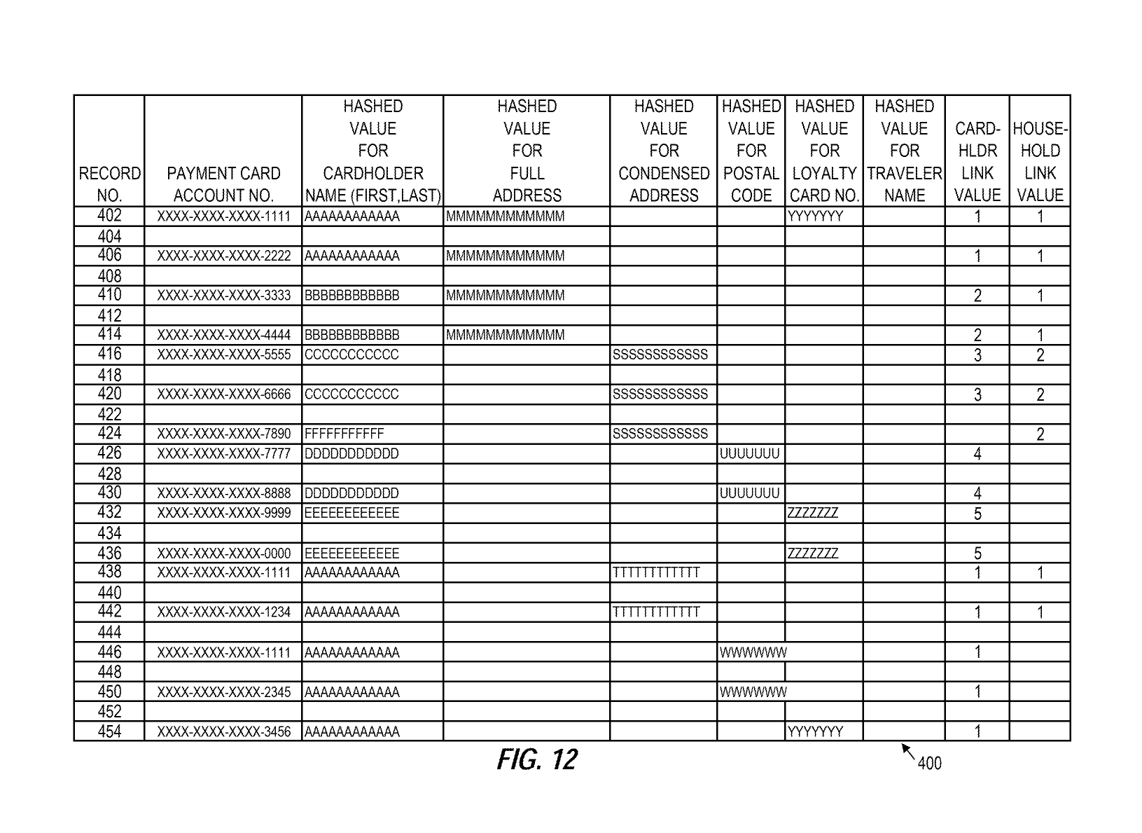

FIG. 12 shows the data of table 400 after 618-620, in accordance with some embodiments.

Referring to FIG. 12, the payment card account number XXXX-XXXX-XXXX-9999 in the record 432 and the payment card account number XXXX-XXXX-XXXX-0000 in the record 436 have been determined as being associated with: (i) a same hashed value for the cardholder name (e.g., a hashed value represented by the string “EEEEEEEEEEEE”) and (ii) a same hashed value for a loyalty card number (e.g., a hashed value represented by the string “ZZZZZZZ”).

In accordance with some embodiments, a cardholder link value (e.g., “5”) in the records 432 and 436 identify the payment card account number XXXX-XXXX-XXXX-9999 in the record 432 and the payment card account number XXXX-XXXX-XXXX-0000 in the record 436 as belonging to the same cardholder.

Similarly, the payment card account number XXXX-XXXX-XXXX-1111 in the record 402 and the payment card account number XXXX-XXXX-XXXX-3456 in the record 454 have been determined as being associated with: (i) a same hashed value for the cardholder name (e.g., a hashed value represented by the string “AAAAAAAAAAAA) and (ii) a same hashed value for a loyalty card number (e.g., a hashed value represented by the string “YYYYYYY”).

In accordance with some embodiments, a cardholder link value (e.g., “1”) in the records 402 and 454 identify the payment card account number XXXX-XXXX-XXXX-1111 in the record 402 and the payment card account number XXXX-XXXX-XXXX-3456 in the record 452 as belonging to the same cardholder.

Thus, in accordance some embodiments, the payment card account number XXXX-XXXX-XXXX-1111 in the records 402, 438, 446, the payment card account number XXXX-XXXX-XXXX-2222 in the record 406, the payment card account number XXXX-XXXX-XXXX-1234 in the record 442, the payment card account number XXXX-XXXX-XXXX-2345 in the record 450 and the payment card account number XXXX-XXXX-XXXX-3456 in the record 454, have been determined as belonging to a same cardholder and identified as belonging to the same cardholder.

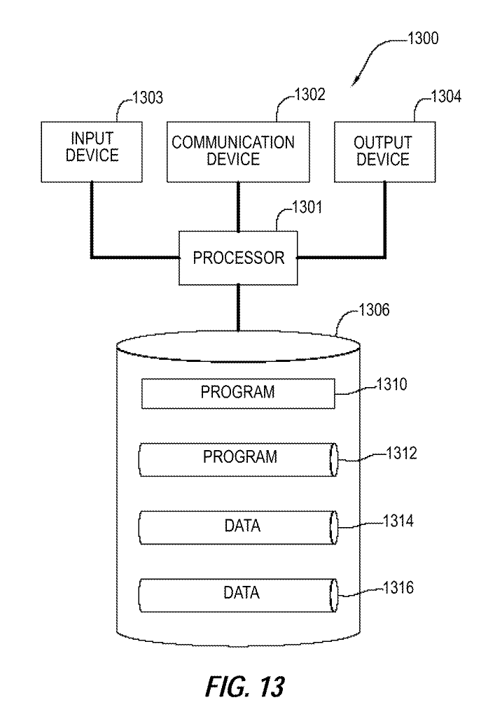

FIG. 13 is a block diagram of an architecture 1300 according to some embodiments. In some embodiments, one or more of the systems and/or devices (and/or portion(s) thereof) disclosed herein may have an architecture that is the same as and/or similar to one or more portions of the architecture 1300.

Referring to FIG. 13, in accordance with some embodiments, the architecture 1300 includes a processor 1301 operatively coupled to a communication device 1302, an input device 1303, an output device 1304 and a storage device 1306.

In some embodiments, the processor 1301 may execute processor-executable program code to provide one or more portions of the one or more functions disclosed herein and/or to carry out one or more portions of one or more embodiments of one or more methods disclosed herein. In some embodiments, the processor 1301 may be a conventional microprocessor or microprocessors.

The communication device 1302 may be used to facilitate communication with other devices and/or systems. In some embodiments, communication device 1302 may be configured with hardware suitable to physically interface with one or more external devices and/or network connections. For example, communication device 1302 may comprise an Ethernet connection to a local area network through which architecture 1300 may receive and transmit information over the Internet and/or one or more other network(s).

The input device 1303 may comprise, for example, one or more devices used to input data and/or other information, such as, for example: a keyboard, a keypad, track ball, touchpad, a mouse or other pointing device, a microphone, knob or a switch, an infra-red (IR) port, etc. The output device 1304 may comprise, for example, one or more devices used to output data and/or other information, such as, for example: an IR port, a display, a speaker, and/or a printer, etc.

The storage device 1306 may comprise, for example, one or more storage devices, such as, for example, magnetic storage devices (e.g., magnetic tape and hard disk drives), optical storage devices, and/or semiconductor memory devices such as Random Access Memory (RAM) devices and Read Only Memory (ROM) devices.

The storage device 1306 may store one or more programs 1310-1312, which may include one or more instructions to be executed by the processor 1301.

In some embodiments, the one or more programs may include one or more operating systems, database management systems, other applications, other information files, etc., for operation of the architecture 1300.

The storage device 1306 may store one or more databases 1314-1316 and/or criteria for one or more programs. As used herein a “database” may refer to one or more related or unrelated databases. Data and/or other information may be stored in any form. In some embodiments, data and/or other information may be stored in raw, excerpted, summarized and/or analyzed form.

In some embodiments, one or more portions of one or more embodiments disclosed herein may be embodied in a method, an apparatus, a computer program product, and/or an article where the article includes a machine readable storage medium with instructions stored thereon. As used herein, a machine may be any type of machine. In some embodiments, a machine comprises a computer. In some embodiments, a machine comprises a proximity coupling system.

As used herein, the term payment card includes but is not limited to credit cards, debit cards, prepaid cards, gift cards and/or any other items that may be used in making cashless payments. Thus, a payment card is not limited to a plastic payment card with a magnetic strip. Some payment cards may be proximity payments cards. Some proximity cards may employ near field communication (NFC) and/or some other type of wireless communication. It should be understood that some types of cashless payments are digital cashless payments and/or cashless payments that are initiated electronically without visiting a merchant location and presenting a payment card in person.

The term “computer” should be understood to include one computer or two or more cooperating computers. Similarly, the term “processor” should be understood to include one processor or two or more cooperating processors. The term “memory” should be understood to encompass a single memory or storage device or two or more memories or storage devices.

A processing device should be understood to include a processor.

Unless stated otherwise, a processor may comprise any type of processor. For example, a processor may be programmable or non programmable, general purpose or special purpose, dedicated or non dedicated, distributed or non distributed, shared or not shared, and/or any combination thereof. A processor may include, but is not limited to, hardware, software, firmware, and/or any combination thereof. Hardware may include, but is not limited to off the shelf integrated circuits, custom integrated circuits and/or any combination thereof. In some embodiments, a processor comprises a microprocessor. Software may include, but is not limited to, instructions that are storable and/or stored on a computer readable medium, such as, for example, magnetic or optical disk, magnetic or optical tape, CD-ROM, DVD, RAM, EPROM, ROM or other semiconductor memory. A processor may employ continuous signals, periodically sampled signals, and/or any combination thereof. If a processor is distributed, two or more portions of the control/storage circuitry may communicate with one another through a communication link.

As used herein, a signal may be any type of signal, i.e., a physical quantity (e.g., voltage, current, or magnetic field), an indication, a message and/or any other type of signal or combination thereof.

Unless otherwise stated, terms such as, for example, “in response to” and “based on” mean “in response at least to” and “based at least on”, respectively, so as not to preclude being responsive to and/or based on, more than one thing.

In addition, unless stated otherwise, terms such as, for example, “comprises”, “has”, “includes”, and all forms thereof, are considered open-ended, so as not to preclude additional elements and/or features. In addition, unless stated otherwise, terms such as, for example, “a”, “one”, “first”, are considered open-ended, and do not mean “only a”, “only one” and “only a first”, respectively. Moreover, unless stated otherwise, the term “first” does not, by itself, require that there also be a “second”.

Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

What is claimed is:

1. A method comprising:
receiving, by a processing device, data representing a plurality of payment card transactions made in association with payment card accounts, the data including personally identifiable information;
anonymizing, by a processing device, the data by hashing the personally identifiable information;
determining, by a processing device, a plurality of the payment card accounts that belong to a same entity based on the hashed personally identifiable information without decoding the hashed personally identifiable information to recover the personally identifiable information; and
identifying, by a processing device, the determined plurality of payment card accounts as belonging to the same entity.

2. The method of claim 1, wherein the receiving data representing a plurality of payment card transactions comprises:
receiving a plurality of records each representing a respective one of the plurality of payment card transactions, each one of the plurality of records including:
a payment card account number associated with the payment card account represented by the one of the plurality of records; and
personally identifiable information associated with a cardholder associated with the payment card account represented by the one of the plurality of records.

3. The method of claim 2, wherein the personally identifiable information included in each one of the plurality of records comprises:
a name of the cardholder; and
at least one of:
a full address associated with the cardholder;
a condensed address associated with the cardholder;
a postal code associated with the cardholder;
a loyalty card number associated with the cardholder; or
a name of a passenger on a ticket for travel purchased using the one of the plurality of payment card transactions represented by the one of the plurality of records.

4. The method of claim 3, wherein the anonymizing the data by hashing the personally identifiable information comprises:
for each record of the plurality of records:
extracting the payment card account number and the personally identifiable information from the record;
hashing the extracted personally identifiable information; and
associating the one of the plurality of payment card account numbers extracted from the record with the hashed personally identifiable information;
wherein the hashed personally identifiable information includes:
a hashed value for the name of the cardholder; and
at least one of:
a hashed value for the full address;
a hashed value for the condensed address;
a hashed value for a postal code;
a hashed value for a loyalty card number; or
a hashed value for the name of the passenger name.

5. The method of claim 3, wherein the determining a plurality of the payment card accounts that belong to a same entity based on the hashed personally identifiable information without decoding the hashed personally identifiable information to recover the personally identifiable information comprises:
determining ones of the plurality of payment account numbers that are associated with: (i) a same hashed value for the name of the cardholder and (ii) a same hashed value for a full address associated with the cardholder; and
wherein the identifying the determined plurality of payment card accounts as belonging to the same entity comprises:
identifying the determined ones of the plurality of payment account numbers that are associated with: (i) a same hashed value for the name of the cardholder and (ii) a same hashed value for a full address associated with the cardholder, as belonging to a same cardholder.

6. The method of claim 3, wherein the determining a plurality of the payment card accounts that belong to a same entity based on the hashed personally identifiable information without decoding the hashed personally identifiable information to recover the personally identifiable information comprises:
determining ones of the plurality of payment account numbers that are associated with: (i) a same hashed value for the name of the cardholder and (ii) a same hashed value for a condensed address associated with the cardholder; and
wherein the identifying the determined plurality of payment card accounts as belonging to the same entity comprises:
identifying the determined ones of the plurality of payment account numbers that are associated with: (i) a same hashed value for the name of the cardholder and (ii) a same hashed value for a condensed address associated with the cardholder, as belonging to a same cardholder.

7. The method of claim 3, wherein the determining a plurality of the payment card accounts that belong to a same entity based on the hashed personally identifiable information without decoding the hashed personally identifiable information to recover the personally identifiable information comprises:
determining ones of the plurality of payment account numbers that are associated with: (i) a same hashed value for the name of the cardholder and (ii) a same hashed value for a postal code associated with the cardholder; and
wherein the identifying the determined plurality of payment card accounts as belonging to the same entity comprises:
identifying the determined ones of the plurality of payment account numbers that are associated with: (i) a same hashed value for the name of the cardholder and (ii) a same hashed value for a postal code associated with the cardholder, as belonging to a same cardholder.

8. The method of claim 3, wherein the determining a plurality of the payment card accounts that belong to a same entity based on the hashed personally identifiable information without decoding the hashed personally identifiable information to recover the personally identifiable information comprises:
determining ones of the plurality of payment account numbers that are associated with: (i) a same hashed value for the name of the cardholder and (ii) a same hashed value for loyalty card number associated with the cardholder; and
wherein the identifying the determined plurality of payment card accounts as belonging to the same entity comprises:
identifying the determined ones of the plurality of payment account numbers that are associated with: (i) a same hashed value for the name of the cardholder and (ii) a same hashed value for a loyalty card number code associated with the cardholder, as belonging to a same cardholder.

9. The method of claim 3, wherein the determining a plurality of the payment card accounts that belong to a same entity based on the hashed personally identifiable information without decoding the hashed personally identifiable information to recover the personally identifiable information comprises:
determining ones of the plurality of payment account numbers that are associated with a same hashed value for a full address; and
wherein the identifying the determined plurality of payment card accounts as belonging to the same entity comprises:
identifying the determined ones of the plurality of payment account numbers that are associated with a same hashed value for a full address, as belonging to a same household.

10. The method of claim 3, wherein the determining a plurality of the payment card accounts that belong to a same entity based on the hashed personally identifiable information without decoding the hashed personally identifiable information to recover the personally identifiable information comprises:
determining ones of the plurality of payment account numbers that are associated with a same hashed value for a condensed address; and
wherein the identifying the determined plurality of payment card accounts as belonging to the same entity comprises:
identifying the determined ones of the plurality of payment account numbers that are associated with a same hashed value for a condensed address, as belonging to a same household.

11. A non-transitory computer readable medium having instructions stored thereon that if executed by a machine result in a method comprising:
receiving data representing a plurality of payment card transactions made in association with payment card accounts, the data including personally identifiable information;
anonymizing the data by hashing the personally identifiable information;
determining a plurality of the payment card accounts that belong to a same entity based on the hashed personally identifiable information without decoding the hashed personally identifiable information to recover the personally identifiable information; and
identifying the determined plurality of payment card accounts as belonging to the same entity.

12. The medium of claim 11, wherein the receiving data representing a plurality of payment card transactions comprises:
receiving a plurality of records each representing a respective one of the plurality of payment card transactions, each one of the plurality of records including:
a payment card account number associated with the payment card account represented by the one of the plurality of records; and
personally identifiable information associated with a cardholder associated with the payment card account represented by the one of the plurality of records.

13. The medium of claim 12, wherein the personally identifiable information included in each one of the plurality of records comprises:
a name of the cardholder; and
at least one of:
a full address associated with the cardholder;
a condensed address associated with the cardholder;
a postal code associated with the cardholder;
a loyalty card number associated with the cardholder; or
a name of a passenger on a ticket for travel purchased using the one of the plurality of payment card transactions represented by the one of the plurality of records.

14. The medium of claim 13, wherein the anonymizing the data by hashing the personally identifiable information comprises:
for each record of the plurality of records:
extracting the payment card account number and the personally identifiable information from the record;
hashing the extracted personally identifiable information; and
associating the one of the plurality of payment card account numbers extracted from the record with the hashed personally identifiable information;
wherein the hashed personally identifiable information includes:
a hashed value for the name of the cardholder; and
at least one of:
a hashed value for the full address;
a hashed value for the condensed address;
a hashed value for a postal code;
a hashed value for a loyalty card number; or
a hashed value for the name of the passenger name.

15. The medium of claim 13, wherein the determining a plurality of the payment card accounts that belong to a same entity based on the hashed personally identifiable information without decoding the hashed personally identifiable information to recover the personally identifiable information comprises:
determining ones of the plurality of payment account numbers that are associated with: (i) a same hashed value for the name of the cardholder and (ii) a same hashed value for a full address associated with the cardholder; and
wherein the identifying the determined plurality of payment card accounts as belonging to the same entity comprises:
identifying the determined ones of the plurality of payment account numbers that are associated with: (i) a same hashed value for the name of the cardholder and (ii) a same hashed value for a full address associated with the cardholder, as belonging to a same cardholder.

16. The medium of claim 13, wherein the determining a plurality of the payment card accounts that belong to a same entity based on the hashed personally identifiable information without decoding the hashed personally identifiable information to recover the personally identifiable information comprises:
determining ones of the plurality of payment account numbers that are associated with: (i) a same hashed value for the name of the cardholder and (ii) a same hashed value for a condensed address associated with the cardholder; and
wherein the identifying the determined plurality of payment card accounts as belonging to the same entity comprises:
identifying the determined ones of the plurality of payment account numbers that are associated with: (i) a same hashed value for the name of the cardholder and (ii) a same hashed value for a condensed address associated with the cardholder, as belonging to a same cardholder.

17. The medium of claim 13, wherein the determining a plurality of the payment card accounts that belong to a same entity based on the hashed personally identifiable information without decoding the hashed personally identifiable information to recover the personally identifiable information comprises:
determining ones of the plurality of payment account numbers that are associated with: (i) a same hashed value for the name of the cardholder and (ii) a same hashed value for a postal code associated with the cardholder; and
wherein the identifying the determined plurality of payment card accounts as belonging to the same entity comprises:
identifying the determined ones of the plurality of payment account numbers that are associated with: (i) a same hashed value for the name of the cardholder and (ii) a same hashed value for a postal code associated with the cardholder, as belonging to a same cardholder.

18. The medium of claim 13, wherein the determining a plurality of the payment card accounts that belong to a same entity based on the hashed personally identifiable information without decoding the hashed personally identifiable information to recover the personally identifiable information comprises:
determining ones of the plurality of payment account numbers that are associated with: (i) a same hashed value for the name of the cardholder and (ii) a same hashed value for loyalty card number associated with the cardholder; and
wherein the identifying the determined plurality of payment card accounts as belonging to the same entity comprises:
identifying the determined ones of the plurality of payment account numbers that are associated with: (i) a same hashed value for the name of the cardholder and (ii) a same hashed value for a loyalty card number code associated with the cardholder, as belonging to a same cardholder.

19. The medium of claim 13, wherein the determining a plurality of the payment card accounts that belong to a same entity based on the hashed personally identifiable information without decoding the hashed personally identifiable information to recover the personally identifiable information comprises:
determining ones of the plurality of payment account numbers that are associated with a same hashed value for a full address; and
wherein the identifying the determined plurality of payment card accounts as belonging to the same entity comprises:
identifying the determined ones of the plurality of payment account numbers that are associated with a same hashed value for a full address, as belonging to a same household.

20. The medium of claim 13, wherein the determining a plurality of the payment card accounts that belong to a same entity based on the hashed personally identifiable information without decoding the hashed personally identifiable information to recover the personally identifiable information comprises:
determining ones of the plurality of payment account numbers that are associated with a same hashed value for a condensed address; and
wherein the identifying the determined plurality of payment card accounts as belonging to the same entity comprises:
identifying the determined ones of the plurality of payment account numbers that are associated with a same hashed value for a condensed address, as belonging to a same household.

21. A system comprising:
a processing device to receive data representing a plurality of payment card transactions made in association with payment card accounts, the data including personally identifiable information;
a processing device to anonymize the data by hashing the personally identifiable information;
a processing device to determine a plurality of the payment card accounts that belong to a same entity based on the hashed personally identifiable information without decoding the hashed personally identifiable information to recover the personally identifiable information; and
a processing device to identify the determined plurality of payment card accounts as belonging to the same entity.
